(19) United States
(12) Patent Application Publication
(10) Pub. No.: US 2004/0227320 A1
(43) Pub. Date: Nov. 18, 2004

(54) Independent front suspension engine attachment

(76) Inventors: David K. Platner, Shelby, MI (US); Mark Belanger, Berkley, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/437,439

(22) Filed: May 13, 2003

(51) Int. Cl. B60G 3/18

(52) U.S. Cl. 280/124.135

(57) ABSTRACT

An independent front suspension system provides includes an engine component as a structural support. The engine component is attached to a longitudinal frame member which is mounted to the longitudinal mainframe. A support structure cradles the engine component between a first and second vertical member. The support structure and the engine component provide a rigid subassembly for attachment of independent suspension components.

### BACKGROUND OF THE INVENTION

The present invention relates to an independent front suspension system, and more particularly to at least partially supporting an independent suspension system with an engine component.

A vehicle such as a tractor of a tractor trailer vehicle commonly includes a main frame having a pair of longitudinally extending members. The members are primary structural components to which other vehicle components are mounted.

The individual assembly and attachment of multiple components to the main frame is a time consuming and labor intensive process. Further, it may be difficult to integrate complex subsystems such as an independent front suspension system to the main frame components. The mounting of an independent front suspension system is particularly difficult due to the multiple attachment and pivot points for the multiple of independently movable components. The proper alignment of each of these components further complicates such an installation.

Accordingly, it is desirable to provide a mounting arrangement for an independent suspension system which thereby reduces the number of assembly steps and contributes to an improvement in productivity, quality and serviceability.

### SUMMARY OF THE INVENTION

The independent front suspension (IFS) system according to the present invention provides an engine component as a structural support. The engine component is also attached to longitudinal frame members which are mounted to the longitudinal mainframe such that the IFS system is mounted as a module to the vehicle.

A substantially U-shaped support structure cradles the engine component between a first and second vertical member. The support structure and the engine component thereby provide a rigid subassembly for attachment of a multitude of other independent suspension components.

The present invention therefore provides an independent suspension system which reduces the number of assembly steps thereby contributing to an improvement in productivity, quality and serviceability.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general partial phantom perspective view an exemplary vehicle embodiment for use with the present invention;

FIG. 2 is an exploded perspective view of independent front suspension (IFS) system of the present invention; and

FIG. 3 is an exploded lower front view of the IFS system of FIG. 2.

### DETAILED DESCRIPTION OF THE PREFERRED EMBODIMENT

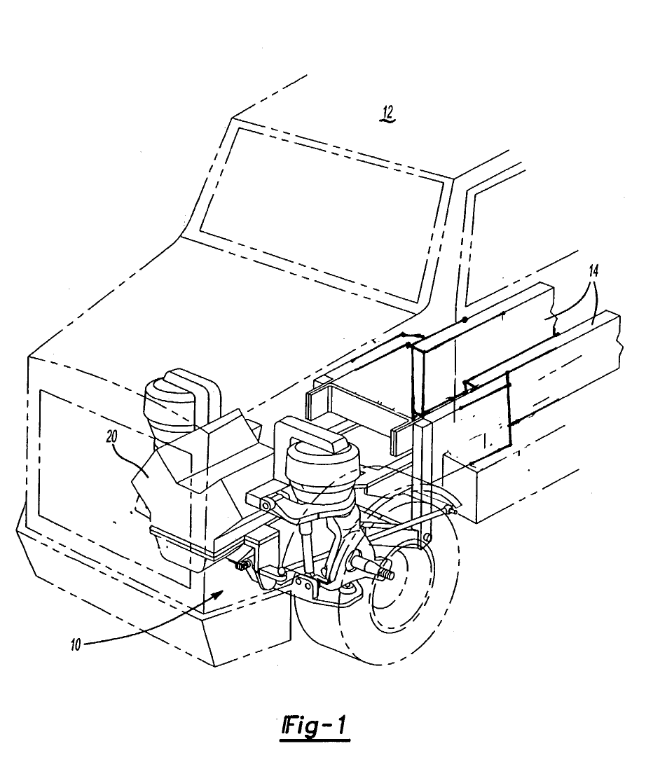

FIG. 1 illustrates a general perspective view of an independent front suspension (IFS) system 10 mated with a generic vehicle. The vehicle 12 is preferably a self-powered vehicle such as a truck tractor which includes a longitudinal mainframe 14. However, it should be realized that many vehicles will benefit from the present invention.

The IFS system 10 includes an engine component 16 as a structural support. The engine component 16 is preferably a plate-like structure attached to an engine (illustrated schematically at 20). Although disclosed in the illustrated embodiment as a flat member, it should be understood that the term “plate” should not be so limited and will encompass any engine structure.

The engine component 16 is attached to a longitudinal frame member 22 which is mounted to the longitudinal mainframe 14. It should be understood that a fastener such as bolts attach the engine component 16 to the other component. Alternatively, or in addition, permanent attachment through welding may also attach the engine component 16 to other structures. The longitudinal frame member 22 preferably provides an intermediate connection to the longitudinal mainframe 14 (FIG. 1) such that the IFS system 10 may be independently assembled as a module then later attached to the longitudinal mainframe 14 of the vehicle. Alternatively, the longitudinal frame member 22 may be the mainframes themselves.

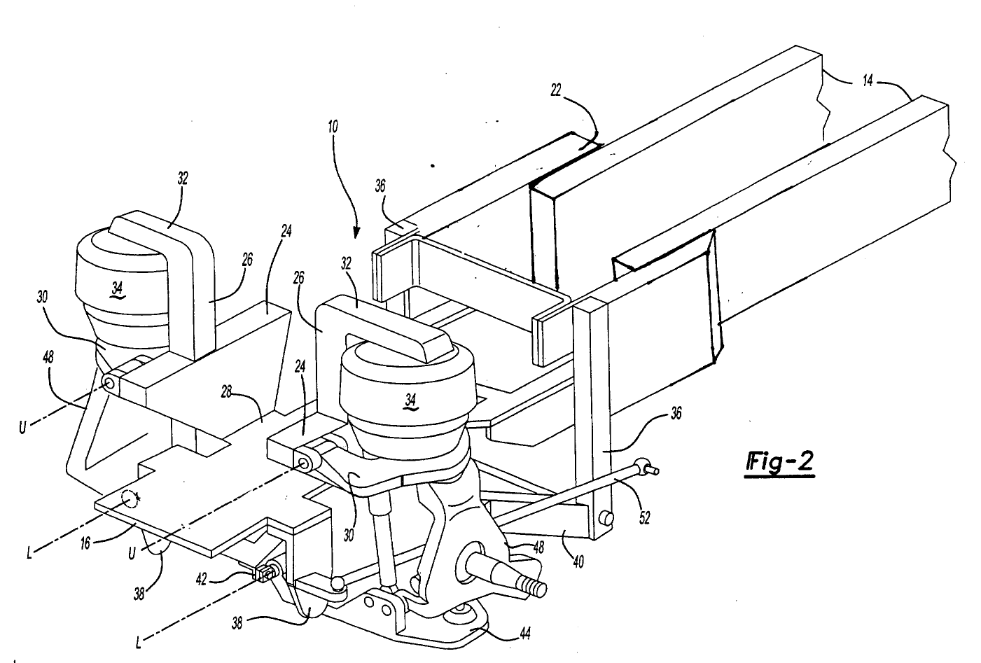

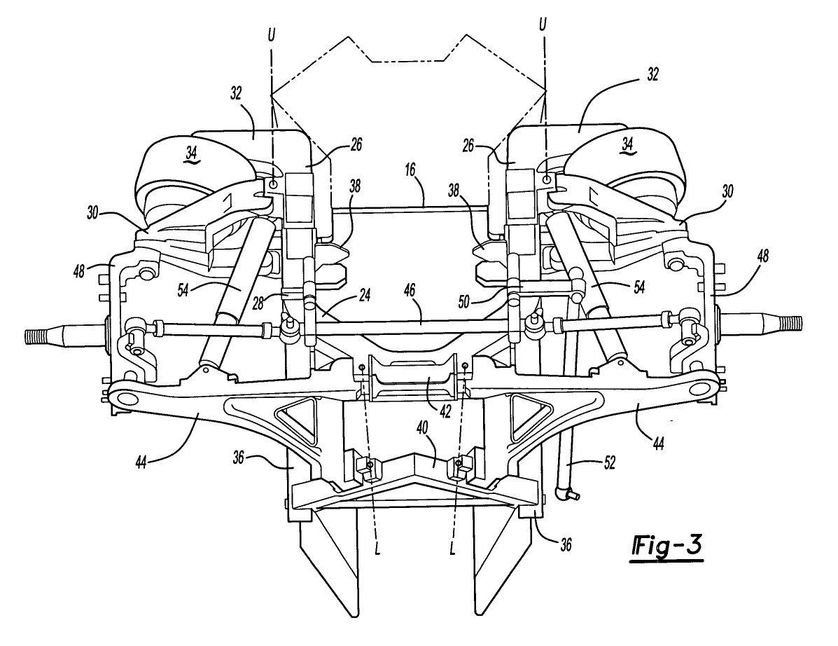

Referring to FIG. 2, the IFS system 10 includes a support structure 24 mounted to the engine component 16. Preferably, the support structure 24 is substantially U-shaped such that the engine component 16 is cradled between a first and second vertical member 26 (FIG. 3). That is, the engine component 16 is substantially perpendicular to and between the vertical members 26. Preferably, the vertical members 26 each receive a tab 28 extending from the edge of the engine component 16. A rigid subassembly is thereby provided by the support structure 24 and the engine component 16.

An upper control arm 30 is pivotally mounted to the support structure 24 along an upper pivot axis U. The upper pivot axis U is generally parallel to the longitudinal frame members 22.

An arm 32 extends from each vertical member 26 substantially perpendicular to the upper pivot axis U and in the same plane as the support structure 24. A spring such as an airbag 34 is mounted between each arm 32 and each upper control arm 30.

An aft brace 36 extends from each longitudinal frame member 22. The aft brace 36 is preferably a pillar arranged substantially parallel to the vertical members 26 and substantially perpendicular to the longitudinal frame member 22.

A forward brace 38 extends from the engine component 16. The forward brace 38 is preferably mounted to the engine component 16 substantially opposite the longitudinal frame member 22 such that the forward brace 38 is substantially parallel to the vertical members 26 and substantially perpendicular to the longitudinal frame member 22.

An aft support 40 is attached between the aft braces 36. The aft support 40 is preferably a substantially triangular member (FIG. 3). A forward support 42 is mounted to the support structure 24. The aft support 40 and the forward support 42 provide attachment points for a lower control arm 44. The lower control arm 44 is pivotally mounted to the support structure 24 and the aft support 40 along a lower pivot axis L. The lower pivot axis L is generally parallel to the upper pivot axis U and the longitudinal mainframe 14. Full independent suspension for each steerable knuckle 48 is thereby provided.

Preferably, the engine component 16 defines a plane located substantially between the upper and lower control arms 30, 44. The rigidity of the IFS system 10 is thereby increased.

Referring to FIG. 3, the forward braces 38 preferably support a steering linkage 46 mounted between each steerable knuckle 48. One forward brace 38 preferably pivotally supports a steering input pivot arm 50. The input pivot 50 operates to translate an input from a steering rod 52 to the steering linkage 46 which is substantially perpendicular thereto. It should be understood that other braces and attachments will benefit from the present invention. The steerable knuckles 48 are each mounted between the respective upper and lower control arm 30, 44.

A damper 54 or the like is mounted between the supports structure 24 and each lower control arm 44 to dampen articulation of the IFS system 10. Other suspension components will also benefit from the present invention which provides an IFS system 10 which obtains primary structural support from an engine component.

Relative positional terms such as “forward,” “aft,” “upper,” “lower,” “above,” “below,” and the like are with reference to the normal operational attitude of the vehicle and should not be considered otherwise limiting.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An independent front suspension system comprising:
an engine component;
a support structure mounted to said engine component; and
an independent front suspension mounted to said support structure.

2. The independent front suspension system as recited in claim 1, further comprising a longitudinal frame member mounted to said engine component.

3. The independent front suspension system as recited in claim 1, wherein said independent front suspension comprises a lower control arm and an upper control arm.

4. The independent front suspension system as recited in claim 3, further comprising an air spring attached to said support structure and said upper control arm.

5. The independent front suspension system as recited in claim 3, further comprising a damper attached to said support structure and said lower control arm.

6. The independent front suspension system as recited in claim 3, further comprising an aft support mounted to a longitudinal frame member, said lower control arm pivotally attached to said aft support.

7. The independent front suspension system as recited in claim 6, further comprising an aft brace attached to said aft support and said longitudinal frame member.

8. The independent front suspension system as recited in claim 3, further comprising a forward support mounted to said support structure, said lower control arm pivotally attached to said forward support.

9. The independent front suspension system as recited in claim 1, further comprising a forward brace attached to said engine component.

10. The independent front suspension system as recited in claim 1, wherein said engine component is a plate.

11. An independent front suspension system comprising:
an engine component;
a longitudinal frame member mounted to said engine component;
a substantially U-shaped support structure mounted to said engine component;
an upper control arm pivotally mounted to said support structure;
an aft support mounted to said longitudinal frame member;
a forward support mounted to said support structure; and
a lower control arm pivotally attached to said forward support and said aft support.

12. The independent front suspension system as recited in claim 11, wherein said engine component is a plate.

13. The independent front suspension system as recited in claim 12, wherein said plate defines a plane between said upper control arm and said lower control arm.

14. The independent front suspension system as recited in claim 12, wherein said plate is mounted between a first and second vertical member of said U-shaped support structure.
